(19) United States
(12) Patent Application Publication
(10) Pub. No.: US 2022/0324271 A1
(43) Pub. Date: Oct. 13, 2022

(54) MULTI-BODY HUBCAP FOR TIRE INFLATION SYSTEMS

(71) Applicant: Equalaire Systems, Inc., Corpus Christi, TX (US)

(72) Inventor: James Sharkey, San Antonio, TX (US)

(21) Appl. No.: 17/634,059

(22) PCT Filed: Aug. 12, 2020
(86) PCT No.: PCT/US2020/046002

§ 371 Date: Feb. 9, 2022

Related U.S. Application Data
(60) Provisional application No. 62/885,647, filed on Aug. 12, 2019.

(51) Int. Cl. B60C 23/00

(52) U.S. Cl. CPC B60C 23/00327; B60C 23/00363

(57) ABSTRACT

A hubcap comprising a base and a cap rotatably coupled to the base.

### CROSS-REFERENCE TO RELATED APPLICATION

This application claims priority to U.S. Provisional Patent Application 62/885,647 entitled “Multi-Body Hubcap for Tire Inflation System” filed Aug. 12, 2019, which is hereby entirely incorporated herein by reference.

### FIELD

This application relates generally to tire inflation systems and the components thereof.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

Automatic tire inflation systems (ATIS) may be used to control vehicle tire pressure by adding fluid to one or more vehicle tires as needed during vehicle operation. An automatic tire inflation system may include a rotary union generally configured to convey pressurized fluid from a vehicle-mounted fluid supply to rotating or rotatable tires. The rotary unions may, for example, be threadably mounted within a hubcap of a vehicle or a rotary union may be mounted to a hubcap using another type of connection that does not permit rotational adjustment of the rotary union to align a rotary union hose connection with a tire valve. Likewise, hubcaps may be attached to a wheel hub via non-rotatable connection. Accordingly, installation and maintenance of ATIS systems may commonly involve over-tightening or under-tightening a rotary union connection to a hubcap increasing risk of damage to the rotary union and associated ATIS components.

There is a need for a rotary union that allows for ready positioning of a hose connection with respect to a tire valve.

### SUMMARY

A hubcap comprising a base having an inboard cylinder and an outboard cylinder, the inboard cylinder having a diameter greater than the diameter of the outboard cylinder, the inboard cylinder and the outboard cylinder joined by a shoulder, the base being configured to removably couple to a vehicle hub. The hubcap further comprising a cap rotatably disposed in the base, the cap being enclosed at a first end by an outboard wall, the cap having a flange extending radially outwardly from a second end of the cap, the flange being configured to engage the shoulder of the base when the first end of the cap extends from the base. The hubcap further comprising a retainer disposed in the base so as to retain the cap in the base; and an annular seal disposed between the cap and the base, the seal configured to substantially seal the cap to the base.

A hubcap comprising a base, a cap rotatably disposed in the base, and an annular seal disposed between the base and the cap.

The hubcap may further have a rotary union integrated into or mounted to the cap, the rotary union being configured to receive pressurized fluid from a vehicle pressure source and communicate the pressurized fluid to a tire through an air connection. The hubcap base may be securely coupled to a vehicle hub, and the cap may be rotated the air connection substantially aligns with a tire valve. The air connection may be couple to the tire valve using an air hose.

### BRIEF DESCRIPTION OF THE DRAWINGS

FIG. 1 illustrates a heavy vehicle having a hubcap.

FIG. 2 is a cross sectional view of an embodiment of a hubcap comprising a base and a cap.

FIG. 3 is a cross sectional view of an embodiment of a hubcap comprising a base and a cap, the cap having a solid outboard wall.

FIG. 4 shows an embodiment of a hubcap comprising a base and a cap, the cap having a rotary union integrated therewith.

FIG. 5 shows a cross-section of the hubcap of FIG. 4, and a stator.

FIG. 6 is a perspective cross-sectional view of an embodiment of a hubcap cap configured to receive a rotary union from the exterior of the cap.

FIG. 7 illustrates an embodiment of a hubcap cap configured to receive a rotary union cartridge at the interior of the cap.

FIG. 8 illustrates an embodiment of a hubcap cap configured to receive a rotary union cartridge at the exterior of the cap.

FIG. 9 is a cross sectional view of another embodiment of a hubcap comprising a base and a cap.

FIG. 10 is a cross sectional view of another embodiment of a hubcap comprising a base and a cap. The base including a cylinder without a flange.

FIG. 11 is a cross sectional view of another embodiment of a hubcap comprising a base and a cap, the cap disposed over an outer surface of the base.

FIG. 12 illustrates an embodiment of a cap having a retaining device.

FIG. 13 illustrates an embodiment of a base have a retaining device.

FIG. 14 illustrates an embodiment of a base having a narrower diameter than a cap.

### DETAILED DESCRIPTION

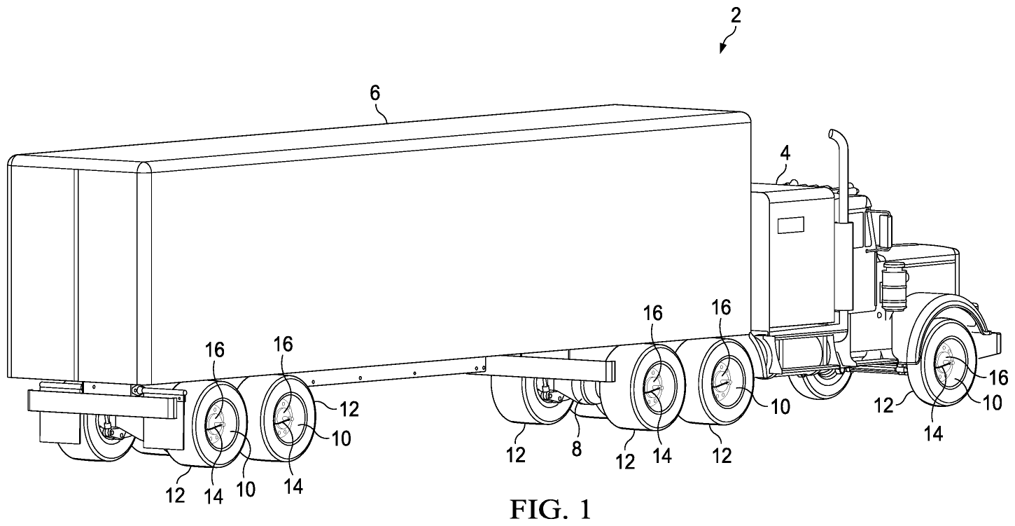

As may be seen in FIG. 1, a vehicle 2 may comprise a truck 4 and a trailer 6. The truck 4 may include one or more drive axles 8 as part of the vehicle's powertrain. The truck 4 may further include a steer axle (not shown in detail) having pivotable spindles that may provide steering capability for the vehicle 2. The trailer 6 may include one or more fixed axles (not shown). Each axle may have one or more wheels 10 mounted thereto. A pneumatic tire 12 may be mounted to each wheel 10. Any axle may terminate in a wheel end wherein a hub and hubcap 16 are components thereof.

The vehicle 2 may be provided with an automatic tire inflation system that may use pressurized fluid from the vehicle's fluid brake system or some other source of pressurized fluid to maintain the tires at a desired fluid pressure. The automatic tire inflation system may be used to control fluid pressure in one or more of the tires 12 mounted to the steer axle (not shown), drive axle 8 and/or trailer axles (not shown). The automatic tire inflation system may include one or more fluid hoses 14 in fluid communication with each tire 12 for communicating fluid from the fluid pressure source to and from one or more of the tires 12.

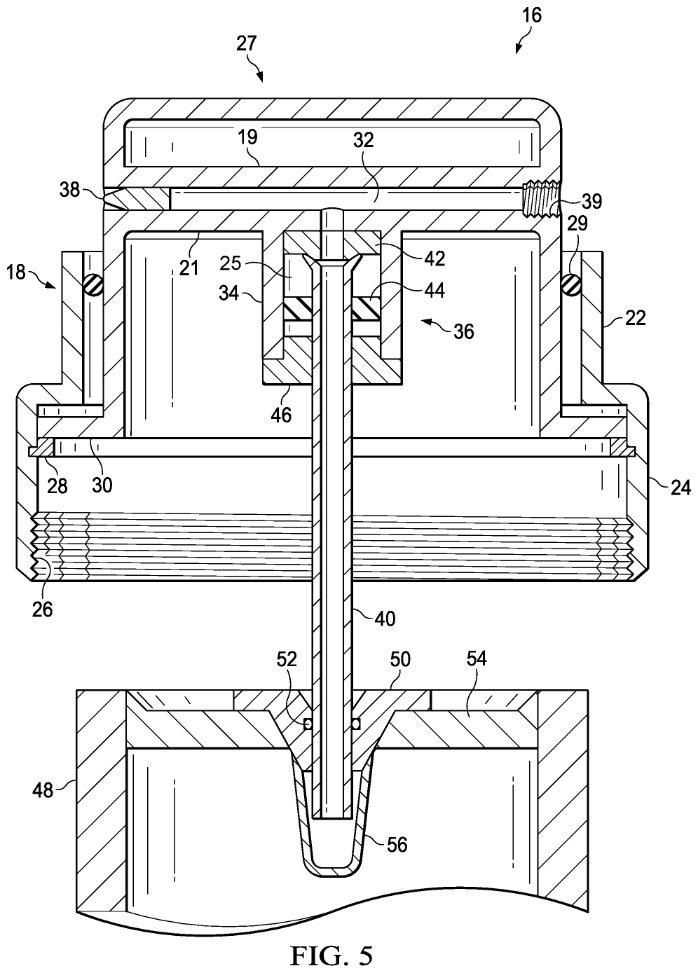

A tire inflation system may route pressurized fluid from an onboard reservoir to one or more tires on the vehicle. Fluid may flow from the reservoir to the tire through various channels, such as the axle, rotary union, and attached fluid hoses. An axle may be pressurized or have a fluid line routed along or through the axle. A hubcap 16 may have a rotary union 36, 68, 62, 72 (shown respectively in FIGS. 5-8) mounted thereto or incorporated therein so as to permit fluid to flow from stationary components of the inflation system and to rotatable components of the inflation system and to the tire.

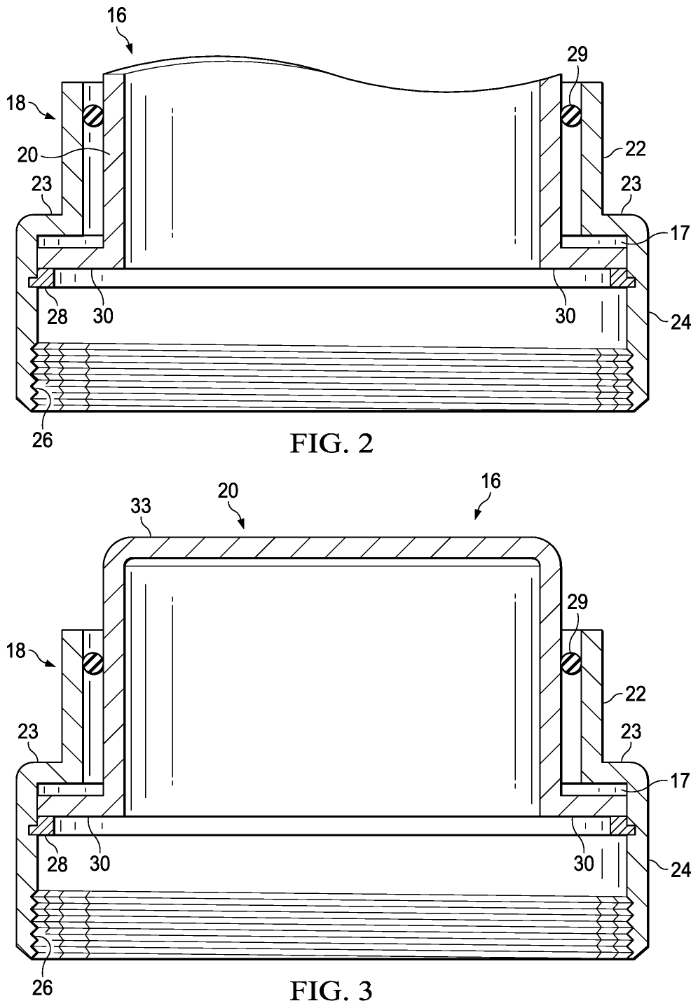

Referring to FIG. 2, a multi-body hubcap 16 may comprise a base 18 and a cap 20. The cap 20 may contain lubrication or seal hub bearings and may be configured to protect lubricated components from contamination. The base 18 is configured to threadably couple to a hub and comprises an outboard cylinder 22 and an inboard cylinder 24. As shown in FIG. 2, the outboard cylinder 22 may be of a lesser diameter than the inboard cylinder 24 and both cylinders are open at both ends. The outboard cylinder 22 and the inboard cylinder 24 are joined at a shoulder 23. The base 18 comprises threads 26 for coupling the hubcap 16 to a hub. In the embodiment disclosed in FIG. 2, the threads 26 are disposed at the interior wall or inner diameter of the inboard cylinder 24. In other embodiments, the threads 26 may be disposed on the exterior of the wall, depending on hub configuration. In yet other embodiments, the threaded connection 26 may be replaced with a flanged connection (not shown) disposed at the inboard exterior of the base 18 so as to accommodate non-threaded hubs. A base 18 may preferably be constructed of cast aluminum, but other materials may be utilized. Such materials may include other metals such as steel or titanium, composite materials such as carbon fiber or fiberglass, or polymers (natural or synthetic) such as urethane, ABS, or polystyrene to name a few examples.

The cap 20 includes a flange 30 extending therefrom. The flange 30 is configured to engage the shoulder 23 of the base 18 to prevent the cap 20 from sliding out the outboard end of the base 18. In some embodiments, a bushing 17 may also be disposed between the shoulder and the cap. The cap 20 is rotatably disposed in the base 18 and can be secured in the base 18 by a retaining device 28 such as a snap ring, inner locking nut, or other retainer. The retaining device 28 does not prevent the cap 20 from rotating with respect to the base 18. Such rotation may be utilized to align each hose connection of a rotary union (shown in FIG. 1) on the hubcap 16 to a corresponding tire valve to permit ready installation of fluid hoses to connect the rotary union to associated tires.

The general geometry of a cap 20 may be of a cylinder with a mating lip or flange 30 at the inboard end and closed at the outboard end. A cap 20 may preferably be constructed of cast aluminum, but other materials may be utilized. Such materials may include other metals such as steel or titanium, composite materials such as carbon fiber or fiberglass, or polymers (natural or synthetic) such as urethane, ABS, or polystyrene to name a few examples.

As seen in FIG. 3, the outboard face 33 of the cap 20 may comprise a solid wall. In other embodiments, the outboard face 33 may be configured in a variety of ways. For example, the outboard face 33 may contain a sight glass, a port for accepting a rotary union, integrated fluid channels, an internal rotary union, internal mating ports for a rotary union, or any combination thereof.

An annular seal 29 is disposed between the base 18 and the cap 20. The seal 29 may comprise an O-ring or a lip seal and may be configured to substantially prevent ingress of contaminants to the interior of the hubcap during normal vehicle operation. The annular seal 29 may thus function to prevent foreign matter intrusion into the hubcap 16 interior. The annular seal may also be configured to vent excess pressure that may form in the interior of the hubcap 16. Thus, the annular seal 29 may not be required to hold pressure inside the hubcap 16 and may release interior pressure at as little as 1 psi of interior hubcap 16 pressure. Some examples of such an annular seal would be a v-ring seal or lip seal. While the annular seal 29 is shown to be disposed adjacent to an interior wall of the outboard cylinder 22 at an outboard end thereof, the seal may be disposed at any point where an exterior surface of the cap 20 and interior surface of the base 18 overlap. For example, the annular seal 29 may be disposed between the flange 30 and the shoulder 23.

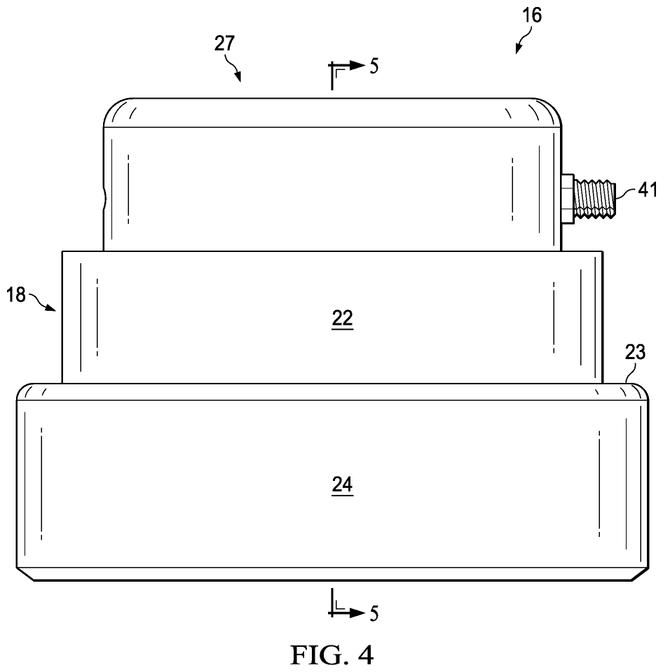

In some embodiments, a cap may include a radial fluid channel. Referring to FIGS. 4 and 5, in an embodiment of cap 27, there may be a radial fluid channel 32 formed in the interior walls 19, 21. FIG. 5 provides a section ‘A-A’ view of the embodiment of FIG. 4, and further shows a fluid conduit from an axle pressure source to the hubcap. In some embodiments, extra channels may be provided to accommodate pressure relief valves or vents (such as vent 38) or a tire pressure monitoring system (TPMS) sensor (not shown). The fluid channel 32 may receive fluid, such as air, from a rotary union 36 which in turn is connected to upstream components of a tire inflation system. The channel 32 may transfer fluid to a pressure relief vent 38 disposed in the fluid channel 32 and also to any fluid hoses that are connected to an associated tire or set of tires. Any such vent 38 may depressurize the inflation system or release excess fluid from an over-pressurized tire. Examples of such a vent may include a duckbill valve, poppet valve, diaphragm valve or other pressure relief valve. A channel 32 may have a threaded port 39 at an exit point from the hubcap. A hose connection adapter 41 may be disposed at the threaded port so that a fluid hose may be connected from the hubcap 16 to a tire.

A rotary union 36 may be integrated into or mount to the cap 20. An integrated rotary union 36 may mount at central boss 34. The central boss 34 may extend from the internal wall 21 and may define a cavity 25 in which components of the rotary union 36 may be disposed. In such an embodiment, the central boss 34 may comprise a rotor body. Such a rotary union 36 may comprise a fluid tube 40, bearing 42, annular seal 44, and telescope cap 46. The annular seal 44 forms a seal between the tube 40 and the hubcap 16 at the central boss 34 so as to substantially prevent fluid flow between the tube 40 and the central boss 34 rotor body so as to substantially prevent fluid escaping from the fluid channels to the interior of the hubcap. The bearing 42 may be disposed adjacent to the fluid channel and include a center orifice through which fluid may pass from the end of the tube 40. As shown in FIG. 5, the end of the tube 40 may be flared, for example. The bearing 42 may prevent damage to the hub and the tube 40 in the event of tube 40 translation in the channel formed by the central boss 34 in which the rotary union 36 components may be disposed. The fluid tube 40 may then be adjacent to the bearing 42 with the annular seal disposed around the exterior of the tube 40 and the telescope cap 46 inserted into the end of the channel boss cavity to seal the cavity. The tube 40 may be flexible or rigid or may comprise both flexible and rigid portions. The tube 40 may rotate and pivot in the annular seal 44.

In other embodiments, a rotary seal may comprise a face seal formed of a graphite member (not shown) abutting the tube 40. The terminus end of the tube 40 may comprise a flat face that may rotate against and with respect to the graphite member.

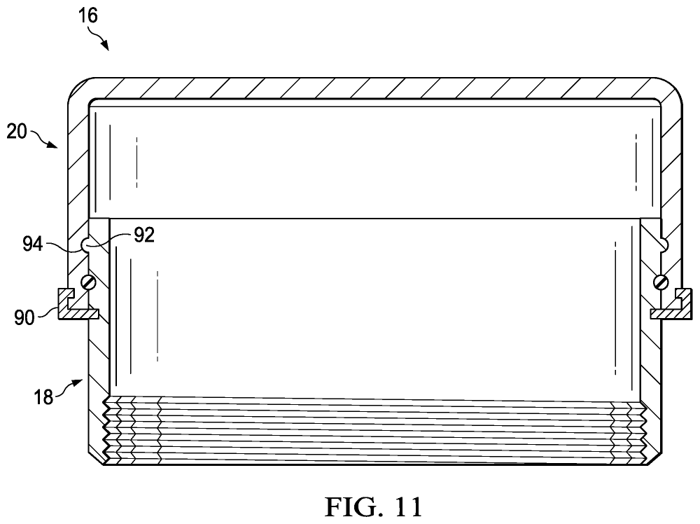

As explained above, the cap 20 may include a flange 30 and may be sealed to attached to an inboard cylinder 24 using a retaining device 28. The cap 20 may be configured to rotate with respect to the base 18 to align a hose connection or a hose connection adapter 41 to a corresponding tire valve to permit ready installation of fluid hoses to connect the rotary union to associated tires. Alternatively, the cap 20 may mount to a base 18 using an external retainer 90 (as explained in relation to FIGS. 10, 11, for example), in which case the cap 20 may not include a flange 30.

In some embodiments, the tube 40 may be in sealed fluid communication with a pressurized axle 48 through a stator 50 with an annular seal 52 disposed between the tube and stator. The stator may couple to a press plug 54 which is in turn disposed at an open end of the axle 48. The press plug 54 may seal the axle 48. In other embodiments, the stator may be retained in the axle and connected to the pressure source through a conduit extending through the axle. Some embodiments may also comprise a fluid filter 56 disposed at the inboard face of the stator 50.

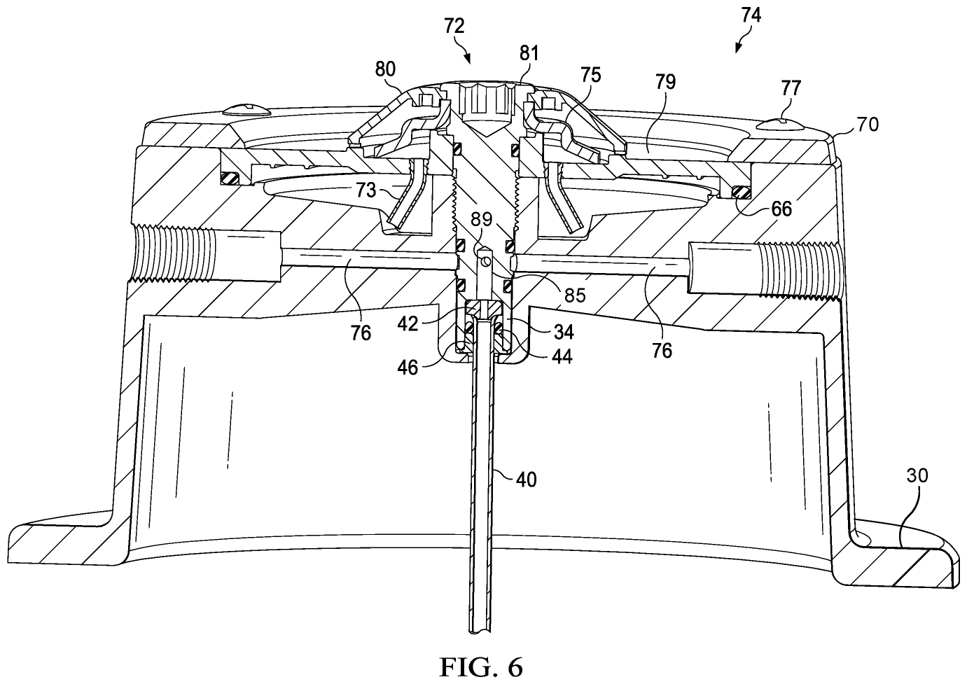

In another embodiment, a cap may accept an internal rotary union that is accessible from the outboard face of the cap. One embodiment of such a rotary union and cap is shown in FIG. 6 and comprises the cap 74, one or more fluid channels 76, annular seal 66, retaining ring 70, sight glass 79, vent shield 80, and rotary union 72. The rotary union 72 may include a rotary body 81 disposed within the cap 74 to provide a boss 34 generally defining a cavity in which components of the rotary union 72 (e.g., bearing 42, annular seal 44, telescope cap 46, and a flanged end of tube 40) may be disposed. The rotary body 81 further comprises a ported fluid chamber 85. The fluid chamber 85 includes one or more ports 89 disposed about the wall of the chamber so as to provide fluid communication between the fluid chamber 85 and an outer surface of the rotor body 81. An outboard face of the cap 74 may be formed primarily by the sight glass 79 sealed to the cap 74 by an annular seal 66 and retained against the hubcap by the retaining ring 70, which may be fixed to the cap 74 by one or more fasteners 77. However, the outboard face may comprise any solid surface sealing or enclosing the outside or free end of the cap 74. The cap 74 may include a flange 30 and may be attached to a base 18 using a retaining device 28, as previously described with respect to the cap 20 shown in FIG. 3, for example. And, as similarly described for the cap 20, the cap 74 may be configured to rotate within the base 18 to align a hose connection of a rotary union 72 to a corresponding tire valve to permit ready installation of fluid hoses to connect the rotary union to associated tires. Alternatively, the cap 74 may mount to a base 18 using an external retainer 90 (as in FIG. 10), in which case the cap 74 may not include a flange 30.

A tube 40 of the rotary union 72 may transfer fluid from a pressurized axle to the rotary union 72. The rotary union 72 may then deliver fluid to the one or more fluid channels 76 disposed in the cap 74. The fluid may then continue through ancillary components of the tire inflation system, such as fluid hoses, that connect tire valves (not shown) to the cap 74. As may be seen in FIG. 6, the hubcap may have one or more vents 73 to allow pressure in the hubcap to be released to atmosphere. A vent 73 may comprise an open tube that is curved so that lubricant may be flung from the end of the tube by centrifugal force when the hubcap rotates with the tire as the vehicle is traveling on a road. The vent shield 80 is disposed over the vents 73 to prevent contaminants from entering the hubcap interior. A flapper disk 75 may be disposed between the vent shield 80 and the vent tubes so as to substantially seal the vents. As fluid is released from the hubcap, the flapper disk 75 may flutter away from the hubcap so as to allow the pressurized fluid to escape. For highly-pressurized hubcaps, the fluid flowing from the vents to atmosphere may cause the flapper disk to flutter with sufficient violence to cause a loud noise, thus permitting a driver to more readily detect the wheel end having the pressurized hubcap.

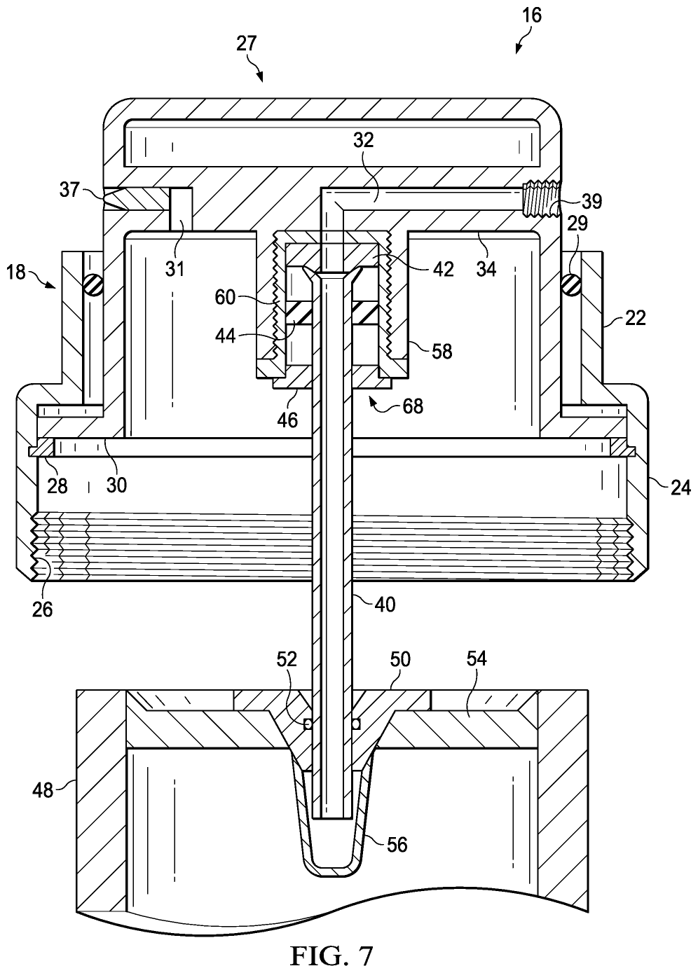

In further embodiments, as seen in FIG. 7, a rotary union 68 may not be integrated into the cap 27 of the hubcap 16. In such embodiments, the hubcap 16 may be configured to receive a rotary union cartridge. The rotary union 68 may comprise a threaded cartridge base 60 serving as a rotor body, a fluid tube 40, bearing 42, annular seal 44, and telescope cap 46. The bearing 42 may be disposed adjacent to the fluid channel and include a center orifice through which fluid may pass from the flared terminus of the tube 40. The bearing 42 may prevent damage to the base 60 and flared end of the tube 40 in the event of tube 40 translation in the channel boss cavity in which the rotary union 68 components may be disposed. The fluid tube 40 may then be adjacent to the bearing 42 with the annular seal 44 disposed around the exterior of the tube 40 and the telescope cap 46 inserted into the end of the channel boss cavity to seal the cavity. The base 60 may then thread into a hubcap boss 58. The rotary union 68 may then interact with the pressurized axle 48 in the same manner as described in embodiments disclosed above.

In some embodiments, the cap 27 may include a fluid passage 31 from the interior of the hubcap to atmosphere or a fluid sink (not shown). A vent 37 may be disposed in the passage so as to control the flow of fluid from the hubcap interior. The vent may only allow fluid release when a particular pressure has been exceeded in the hubcap interior wherein such a pressure is due to a leak in the tire inflation system, or triggering a pneumatic high-temperature warning system, or other high-pressure event. Examples of such a vent 37 may include a duckbill valve, poppet valve, or other pressure relief valve.

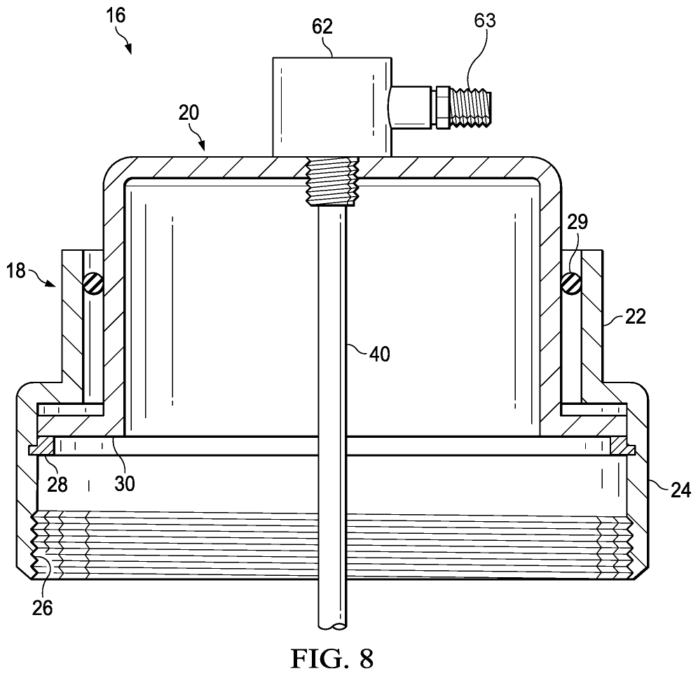

In other embodiments, a threaded port may be disposed at the outboard face of the cap 20 so as to accept a rotary union 62 wherein the rotary union is external to the cap 20, as seen in FIG. 8. The rotary union may comprise a rotor body, tube and annular seal as described above, or may comprise a face seal as described above. In such an embodiment, the rotary union may be threaded to the cap 20. The rotary union may include an air connection 63. An air hose (not shown) may be coupled to the air connection and tire valve (not shown) so as to permit fluid to flow from the rotary union to the tire. The cap may rotate on retaining device 28 to align the air connection to a corresponding tire valve.

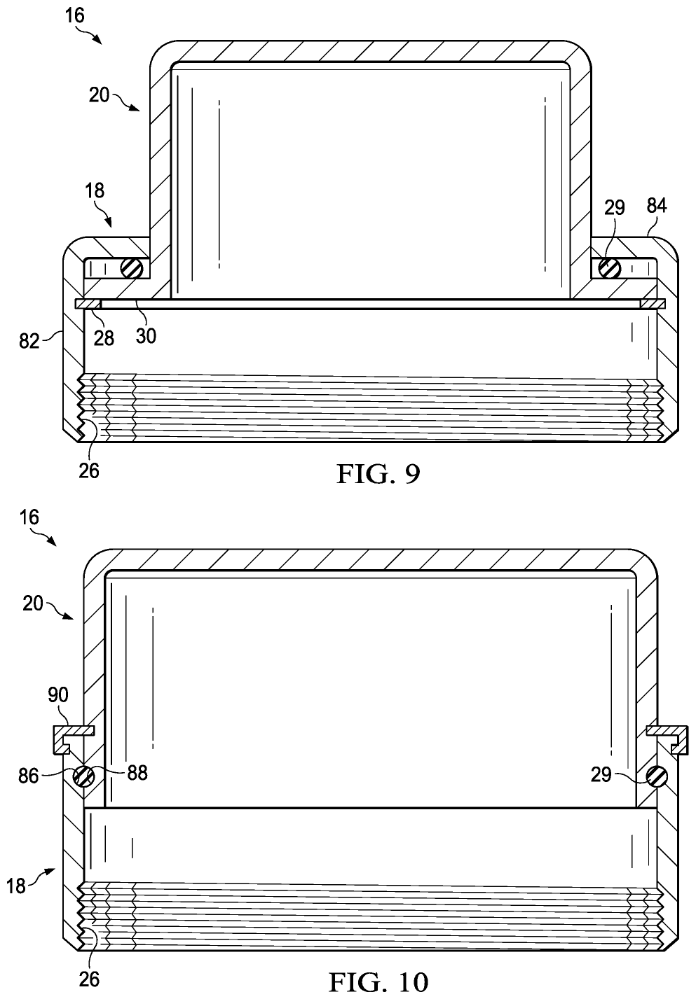

As illustrated in the embodiment of FIG. 9, the base 18 may have a generally L-shape in cross-section. Such a shape may form a cylindrical wall 82 and an adjacent flange 84. When the base 18 is rotatably coupled to the cap 20, an annular seal 29 may be disposed between the flange 84 and a lip 30 of the cap 20. The annular seal 29 may be prevented from slipping from the intended location by compression between said flange and lip. Alternately, in some embodiments an annular groove may be disposed in the flange 84, the mating lip 30, or in both so as to provide a seating area for the annular seal 29. A retaining ring 28 may be disposed at the inboard face of the lip 30 and snap into a groove in the cylindrical wall 82 such that said retaining ring and said lip substantially prevent translation of the cap 20 in relation to the base 18.

In further embodiments, as seen in FIG. 10, the base 18 may comprise a cylinder without a flange. The inboard terminus of the cylinder wall may have a taper to assist in seating the base to a wheel hub. The base be threaded 26 to provide a threaded connection with a vehicle hub, but in some embodiments may be flanged or otherwise configured to attach to any style of wheel hub, such as by hub bolts. The cylinder wall of the base 18 may have an annular groove 86 and the cap 20 may have a corresponding annular groove 88, in which the annular seal 29 may be disposed and retained. Said base and cap may be joined together by means of an external retainer ring 90. Such a retainer may insert to a groove on the exterior of the base and a groove on the base. Said groove may be annular, semi-circumferential, or limited to the size required to insert and remove the retaining device. A limited-size groove may allow the cap and base to align in a particular orientation, while the annular or semi-circumferential groove may allow a greater freedom of orientation between the base and cap.

In some embodiments, as seen in FIG. 11, the cap 20 may be disposed over the outer surface of the base 18 such that the base is seated inside the rim of the cap. The outer wall of the base may have a secondary retaining device 92 that seats in a recess 94 of the inner wall of the cap. The cylinder wall of the base 18 may have an annular groove and the cap may have a corresponding annular groove in which an annular seal 29 may be disposed and retained. The engagement of a secondary retaining device 92 and a recess 94 may serve to ensure that the cap and base are properly aligned as to depth of insertion. The secondary retaining device may be a simple protrusion of the wall or may be an element that slightly depresses until the recess aligns with the secondary retaining device. Upon alignment, the protrusion enters the recess and makes further insertion difficult or the element moves from the depressed position to enter the recess and thus indicate proper insertion. Such an indication may auditory (a clicking noise), tactile (feeling a click), or a visual inspection may verify the alignment. Visual inspection may be aided by a mark on the exterior of the base, a sight window, or other common visual cues. Said base and cap may be joined together by an external retainer 90. Such a retaining device may insert to a groove on the exterior of the base and a groove on the base. Said groove may be annular, semi- circumferential, or limited to the size required to insert and remove the retaining device. A limited size groove may allow the cap and base to align in a particular orientation, while the annular or semi-circumferential groove may allow a greater freedom of orientation between the base and cap.

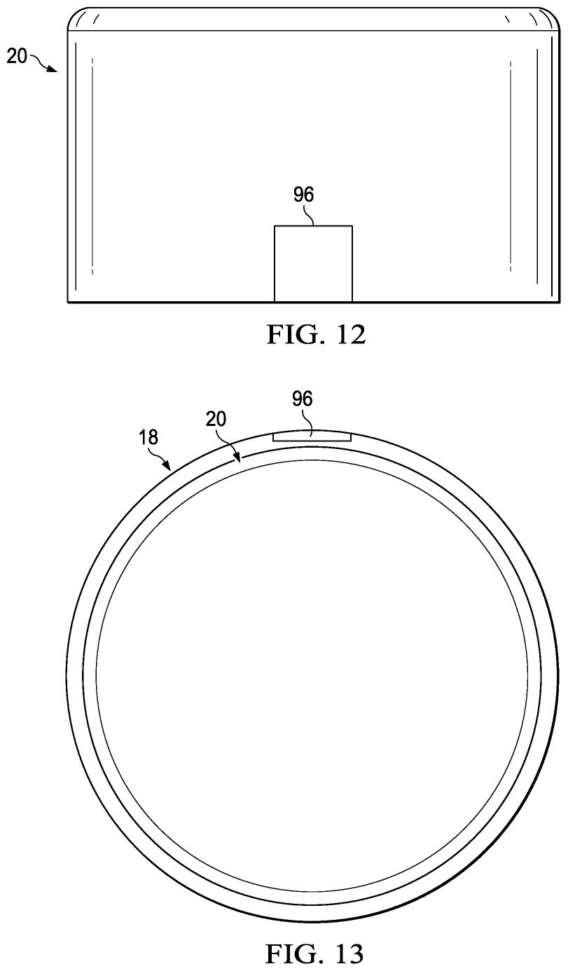

In some embodiments, as seen in FIGS. 12-13, a hubcap may have a retaining device that requires a tool to release the device. A recess 96 may be disposed in the outer surface of cap 20 so as that a said tool may access said retaining device. For example, a retaining device may be a snap ring wherein said snap ring has protruding ears with holes for a set of snap ring pliers. These holes may be aligned into the recess 96 such that the recess then prevents interference between the wall of the cap 20 and the end of said pliers as the pliers access the snap ring. Alternately, the recess 96 (FIG. 13) may be disposed in the base 18.

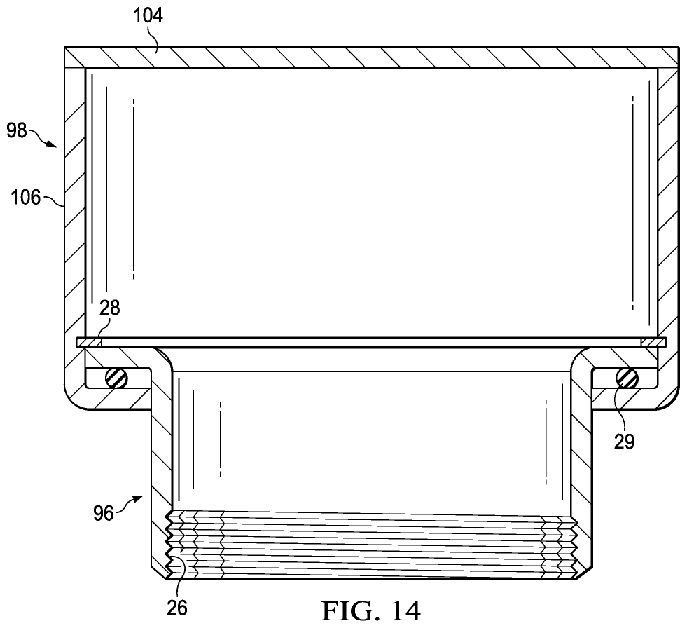

Another embodiment, as seen in FIG. 14, may have a base 96 of narrower diameter than the cap 98. An annular seal 29 may be disposed between a flange 100 of said base and a flange 102 of said cap. The interference between these flanges 100 and 102 prevents the cap and base from disengaging from one another if the cap moves in an outboard direction. A retaining ring 28 such as a snap ring may engage into a recess disposed at the internal wall of the cap and the outboard face of the base flange 100. In other embodiments, a retaining device that is external to the cap and base, as described in prior embodiments, may be utilized rather than an internal retaining device. The cap 98 may be open or mostly open at the outboard face so as to allow visual access to the interior of the hubcap. This open end may then be sealed by means of a sight glass 104 or other solid cover wherein said sight glass bolts to the outboard face of the cap wall 106. Said sight glass may be configured to self-seal with the rim of the cap wall 106 or there may be an annular seal (not shown) disposed between the sight glass and cap. Said seal may be a gasket, o-ring, or other suitable sealing device. The sight glass may have a rotary union body formed or disposed therein in the manner described in connection with other embodiments above.

As may be seen in the foregoing embodiments, when the hubcap base 18 is securely threaded to the hub, the fluid channels or air connections may not line up with a corresponding tire valve. Particularly with rotary unions provided for super-wide single tires in which the wheel end only has a single tire rather than dual tires mounted thereto, the air connection may be up to 180 degrees away from the tire valve. Loosening or over-tightening the threaded connection between the hubcap and hub, and/or between the rotary union and hubcap, as the case may be, is disadvantageous in that such approaches to aligning the air connection and tire valve may damage the components or render them difficult to remove, or increase risk of loss. Accordingly, a hubcap as disclosed herein may be advantageously used. After the hubcap and rotary union are installed, the cap portion of the hubcap may be rotated within the base to align the air connection of the hubcap or rotary union, as the case may be, with the corresponding tire valve. After such alignment, an air hose may be coupled to the air connection and tire valve to permit pressurized fluid to flow from the rotary union to the tire.

An annular seal may be an O-ring, lip seal or any other suitable seal configuration, and may comprise a variety of materials, such as rubber, silicone, nylon, oilite or graphite.

The foregoing embodiments have focused on a supporting a single standard or super-single tire, yet the pressure of more than one tire may be managed by the inflation system routed to a hubcap. To accomplish multi-tire support, in any and all possible embodiments, the number of fluid channels and associated components may correspond to the number of tires on the wheel end for which the particular hubcap is to be used.

Although the disclosed subject matter and its advantages have been described in detail, it should be understood that various changes, substitutions and alterations can be made herein without departing from the subject matter as defined by the appended claims. Moreover, the scope of the present application is not intended to be limited to the particular embodiments of the process, machine, manufacture, composition, or matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. For example, although the disclosed apparatus, systems and methods may be described with reference to a manual or manually-activated pressure reduction valve, an electric valve or other automatic electronic or mechanical valve may be used to accomplish relatively rapid reduction of fluid pressure. Accordingly, the appended claims are intended to include within their scope such processes, machines, manufacture, compositions of matter, means, methods, systems or steps.

What is claimed is:

1. A hubcap comprising:
a base configured to removably couple to a vehicle hub; and
a cap rotatably coupled to the base.

2. The hubcap of claim 1 further comprising an annular seal disposed between the base and the cap so as to substantially seal the cap to the base.

3. The hubcap of claim 2 further comprising a vent configured to release pressurized fluid from the hubcap.

4. The hubcap of claim 1, further comprising:
the base having an inboard cylinder and an outboard cylinder, the inboard cylinder having a diameter greater than the diameter of the outboard cylinder, the inboard cylinder and the outboard cylinder joined by a shoulder;
the cap being enclosed at a first end by an outboard wall, the cap having a flange extending radially outwardly from a second end of the cap, the flange being configured to engage the shoulder of the base when the first end of the cap extends from the base; and
a retainer disposed on the base so as to retain the cap in the base.

5. The hubcap of claim 1, further comprising:
the base having an inboard cylinder and an outboard cylinder, the inboard cylinder having a diameter less than the diameter of the outboard cylinder, the inboard cylinder and the outboard cylinder joined by a shoulder;
the cap being enclosed at a first end by a removable outboard cover, the cap having a flange extending radially inwardly from a second end of the cap, the flange being configured to engage the shoulder of the base when the first end of the cap extends from the base; and
a retainer disposed about the base or in the cap so as to retain the base in the cap.

6. The hubcap of claim 1 wherein the cap comprises a solid outboard wall.

7. The hubcap of claim 1 wherein the cap includes an outboard face including a port configured for accepting a rotary union.

8. The hubcap of claim 1 wherein the cap includes one or more internal walls, one or more radial fluid channels formed in the one or more internal walls.

9. The hubcap of claim 1, the base having threads for threaded coupling to a hub.

10. The hubcap of claim 1 further having a rotary union integrated into or mounted to the cap, the rotary union being configured to receive pressurized fluid from a vehicle pressure source and communicate the pressurized fluid to a tire through an air connection.

11. The hubcap of claim 10, the rotary union comprising:
a rotor body;
a tube having an end disposed in the rotor body; and
an annular seal disposed about the tube, the annular seal being configured to substantially prevent pressurized fluid from flowing between the rotor body and the tube.

12. The hubcap of claim 11 the rotary union further comprising a telescope cap.

13. The hubcap of claim 11 wherein the tube is sealingly disposed in said rotor body using one or more annular seals.

14. The hubcap of claim 11 wherein the tube is rigid, or flexible, or may include both a flexible portion and a rigid portion.

15. The hubcap of claim 11 wherein the tube is pivotably and translatably disposed in the annular seal.

16. The hubcap of claim 11 wherein the tube is in sealed fluid communication with an axle through a stator with a second annular seal disposed between the tube and stator.

17. The hubcap of claim 16 wherein the tube is coaxially extendable and translatably disposed in the axle.

18. The hubcap of claim 4 wherein the retainer comprises a snap ring or an inner locking nut.

19. The hubcap of claim 4 further comprising a bushing disposed between the shoulder and the cap.

20. A method of orienting a hubcap, the method comprising:
on a hubcap comprising a base and a cap rotatably coupled to the base, disposing a rotary union in or on the cap, the rotary union being configured to receive pressurized fluid from a vehicle pressure source and communicate the pressurized fluid to a tire through an air connection; securely coupling a hubcap to a vehicle hub; and
rotating the cap so that the air connection substantially aligns with a tire valve.

21. The method of claim 20 further comprising coupling the air connection to the tire valve using an air hose.
